(19) United States
(12) Patent Application Publication
(10) Pub. No.: US 2026/0345306 A1
(43) Pub. Date: Nov. 5, 2026

(54) ELECTRIC TOOTHBRUSH

(71) Applicant: NINGBO SEAGO ELECTRIC CO., LTD., Ningbo City (CN)

(72) Inventors: Yanzhong Cai, Ningbo City (CN); Zhuting Dong, Ningbo City (CN); Yuli Wang, Ningbo City (CN)

(21) Appl. No.: 19/297,066

(22) Filed: Aug. 12, 2025

(30) Foreign Application Priority Data
Apr. 30, 2025 (CN) 202520867524.4

(51) Int. Cl. A61C 17/34; A46B 5/00; A46B 13/02

(52) U.S. Cl. CPC A61C 17/3481; A46B 5/00; A46B 13/023

(57) ABSTRACT

An electric toothbrush includes: support frame provided with hollow part; drive frame elastically connected to support frame through elastic parts and connecting part; drive frame includes frame body and drive shaft extending from frame body to upper side of electric toothbrush; connecting part is connected around drive shaft and spaced apart from the frame body in upward/downward direction of electric toothbrush; the frame body is positioned in hollow part and spaced apart from support frame in at least leftward/rightward direction of electric toothbrush; drive shaft is configured to be connected to toothbrush head; a sealing member is sleeved around the drive shaft and mounted to the support frame close to a position where the elastic parts are connected; the connecting part is located in the same plane as a front end of the support frame and can contact the sealing member; and a motor is arranged on the frame body.

### CROSS-REFERENCE TO RELATED APPLICATIONS

The present disclosure claims the priority to the Chinese patent application No. 202520867524.4 filed with the Chinese Patent Office on Apr. 30, 2025, and entitled “ELECTRIC TOOTHBRUSH”, the contents of which are incorporated herein by reference in entirety.

### TECHNICAL FIELD

The present disclosure relates to the technology field of oral hygiene and in particular to an electric toothbrush.

### BACKGROUND ART

An electric toothbrush produces high-frequency vibration in a toothbrush head by rapid rotation or vibration of an electric core, by which toothpaste is instantaneously decomposed into fine foam and deeply cleans crevices between teeth. Meanwhile, the fluttering of bristles can facilitate blood circulation in the mouth and has the effect of massaging gum tissue.

In the prior art, an eccentric block is rotationally driven by a motor to produce vibration; however, a liquid often permeates into the inside of the handle through a gap produced by the vibration at the drive shaft position connected to the toothbrush head, leading to a poor sealing effect, which affects the service life of the electric toothbrush.

### SUMMARY

In order to overcome or alleviate the above-mentioned problems existing in the prior art, the present disclosure aims to provides an electric toothbrush, in which the sealing property of the drive shaft position is improved to prolong the service life of the electric toothbrush.

The present disclosure proposes an electric toothbrush, comprising:
a support frame provided with a hollow part;
a drive frame, wherein the drive frame is elastically connected to the support frame through an elastic part and a connecting part, the drive frame comprises a frame body and a drive shaft extending from the frame body to an upper side of the electric toothbrush, the connecting part is connected around the drive shaft, and in an upward/downward direction of the electric toothbrush, the connecting part is spaced apart from the frame body in the upward/downward direction of the electric toothbrush;
the frame body is positioned in the hollow part, the frame body is spaced apart from the support frame in at least a leftward/rightward direction of the electric toothbrush so that the frame body is movable relative to the support frame; the drive shaft is configured to be connected to a toothbrush head, and a sealing member is sleeved around the drive shaft; the sealing member is mounted to the support frame closely to a position where the elastic part is connected so that a swing amplitude of the drive shaft at the sealing member is smaller than a swing amplitude of a distal end of the drive shaft; the connecting part is located in the same plane as a front end of the support frame; and the sealing member can be brought into contact with the connecting part; and
a motor arranged on the frame body, wherein the motor is able to drive the drive frame to swing or vibrate relative to the support frame around a fulcrum on the drive shaft, so that the drive shaft can drive the toothbrush head to swing or vibrate.

In at least one possible embodiment, a distance between the sealing member and the fulcrum in the upward/downward direction is less than ⅓ of a length of the drive shaft; and
a waterproof ring is arranged over the sealing member, and the waterproof ring and the sealing member are brought into fit connection with each other.

In at least one possible embodiment, when viewed along a frontward/rearward direction of the electric toothbrush, the elastic parts are arranged to be inclined relative to the leftward/rightward direction and the upward/downward direction of the electric toothbrush, and the elastic parts are closer to the rear of the electric toothbrush as they extend to the left and right sides.

In at least one possible embodiment, the drive frame, the elastic parts, the connecting part, and the support frame are integrally molded.

In at least one possible embodiment, in the upward/downward direction of the electric toothbrush, the connecting part is positioned at upper ends of the elastic parts,
the drive shaft and the connecting part are integrally connected by an injection molding process.

In at least one possible embodiment, the elastic part has a rectangular cross section, and the connecting part and the elastic part have identical dimensions along a frontward/rearward direction of the electric toothbrush.

In at least one possible embodiment, an upper end portion of the frame body is formed as a first inverted U-shaped portion open toward the left and right sides of the electric toothbrush, the drive shaft protrudes upwards from a top end of the first inverted U-shaped portion, the connecting part and the elastic parts are formed together as a second inverted U-shaped portion open toward the left and right sides of the electric toothbrush, and the second inverted U-shaped portion with a similar shape to that of the first inverted U-shaped portion is sleeved over the outside of the first inverted U-shaped portion with a spacing therebetween.

In at least one possible embodiment, the frame body is connected with a counterweight.

In at least one possible embodiment, an output shaft of the motor is connected with an eccentric block, the drive frame can be swung or vibrated by driving a rotation of the eccentric block by the motor, and in the upward/downward direction of the electric toothbrush, the eccentric block is positioned on a lower side of the motor, and the counterweight is positioned on a lower side of the eccentric block.

In at least one possible embodiment, the frame is provided with a battery accommodating groove in which a battery is mounted.

According to the above-mentioned technical solutions, there is a short distance between the sealing member and the fulcrum, and thus, at the position where the sealing member is located, the drive shaft has a smaller swing amplitude and is subjected to less resistance, and the sealing member has a better waterproof effect.

### BRIEF DESCRIPTION OF DRAWINGS

FIG. 1 shows an exploded view of a partial structure of an electric toothbrush according to an embodiment of the present disclosure.

FIG. 2 shows a schematic structural diagram of a support frame and a drive frame of an electric toothbrush according to an embodiment of the present disclosure.

FIG. 3 shows a structural front view of a support frame and a drive frame of an electric toothbrush according to an embodiment of the present disclosure.

FIG. 4 shows a structural rear view of a support frame and a drive frame of an electric toothbrush according to an embodiment of the present disclosure.

FIG. 5 shows a structural side view of a support frame and a drive frame of an electric toothbrush according to an embodiment of the present disclosure.

### DESCRIPTION OF THE REFERENCE NUMERALS

1 support frame; 11 hollow part; 12 sealing member mounting hole; 13 battery accommodating groove;
2 drive frame; 21 drive shaft; 22 motor groove; 23 counterweight groove; elastic part; 25 connecting part;
3 counterweight;
4 motor; 41 eccentric block;
5 shock absorber;
6 battery;
7 circuit board;
8 sealing member;
9 waterproof ring;
P fulcrum;
A upward/downward direction; F frontward/rearward direction; R leftward/rightward direction.

### DETAILED DESCRIPTION OF EMBODIMENTS

In order to more clearly elaborate the above objectives, features, and advantages of the present disclosure, specific embodiments of the present disclosure are described in detail herein with reference to the drawings. The present disclosure can be implemented in other different ways in addition to the various embodiments described herein, and those skilled in the art can make corresponding improvements, variations, and replacements without departing from the spirit of the present disclosure, hence the present disclosure is not limited by the specific embodiments disclosed herein. The scope of protection of present disclosure shall be defined by the claims.

In the following description, an upward/downward direction A of an electric toothbrush represents a direction in which an axis of the electric toothbrush extends, where the upper side represents a side where a toothbrush head is located, and the lower side represents a side where a toothbrush handle is located. A frontward/rearward direction F of the electric toothbrush represents a direction in which bristles of the toothbrush head of the electric toothbrush extend, where the front side represents a side which the bristles are facing, and the rear side represents a side from which the bristles face away. A leftward/rightward direction R of the electric toothbrush is perpendicular to both the upward/downward direction A and the frontward/rearward direction F of the electric toothbrush.

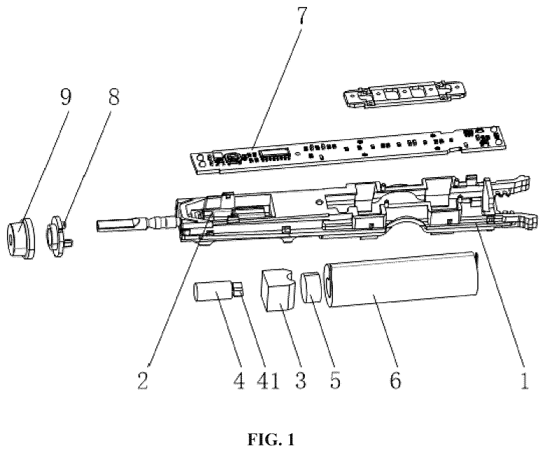

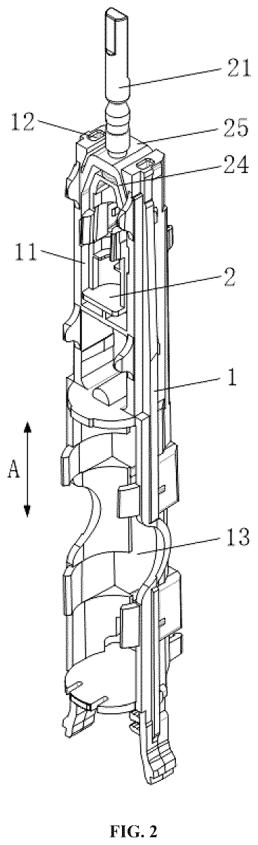

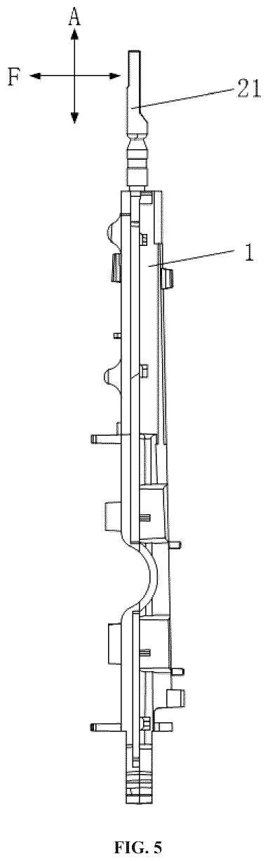

As shown in FIG. 1 to FIG. 5, an embodiment of the present disclosure provides an electric toothbrush which comprises a toothbrush handle and a toothbrush head (not shown), where the toothbrush head is mounted to an upper end of the toothbrush handle in a replaceable manner.

The toothbrush handle comprises a housing (not shown), a support frame 1, a drive frame 2, a counterweight 3, a motor 4, a shock absorber 5, a battery 6, a circuit board 7, a sealing member 8 (e.g., an annular sealing ring), and a waterproof ring 9. An upper end of the housing has an opening, and the support frame 1, the drive frame 2, the counterweight 3, the motor 4, the shock absorber 5, the battery 6, the circuit board 7, the sealing member 8, and the waterproof ring 9 can be arranged inside the housing. The waterproof ring 9 can be mounted to a front end of the housing of the toothbrush handle, the waterproof ring 9 can cover the opening of the housing of the toothbrush handle, and a drive shaft 21 described later can pass through the waterproof ring 9. The waterproof ring 9 is positioned over the sealing member 8, and the waterproof ring 9 is brought into fit connection (not limited to interference fit/transition fit/clearance fit) with the sealing member 8. For example, an upper end of the sealing member 8 can be provided with an annular protrusion, a lower end of the waterproof ring 9 can be provided with a groove fitting the annular protrusion, and the sealing property of the connection therebetween can be increased by fitting of the annular protrusion in the groove.

The battery 6 and the circuit board 7 can be fixedly connected to the support frame 1. For example, the support frame 1 can be provided with a battery accommodating groove 13, and the battery 6 is mounted in the battery accommodating groove 13.

The counterweight 3, the motor 4, and the shock absorber 5 can be mounted to the drive frame 2, and the drive frame 2 can be elastically connected to the support frame 1 through an elastic part 24.

The support frame 1 can be provided with a hollow part 11, the hollow part 11 can be positioned at an upper portion of the toothbrush handle in the upward/downward direction A, and the hollow part 11 can be positioned at the middle position of the electric toothbrush in the leftward/rightward direction R.

The drive frame 2 can comprise a frame body and a drive shaft 21 extending from the frame body to the upper side of the electric toothbrush in the upward/downward direction A, the drive shaft 21 is configured to be connected to the toothbrush head, and the toothbrush head is detachably connected to the drive shaft 21 in a and replaceable manner. The drive shaft 21 can have a columnar shape, and the drive shaft 21 can be made of a metal material and have good rigidity.

The frame body can comprise a motor groove 22, and the motor 4 can be accommodated in the motor groove 22. In the upward/downward direction A of the electric toothbrush, the drive shaft 21 can be positioned on an upper side of the motor groove 22. An eccentric block 41 can be mounted to an output shaft of the motor 4 so that vibration can be produced when the motor 4 rotates. In the upward/downward direction A of the electric toothbrush, the eccentric block 41 can be positioned on a lower side of the motor 4.

The drive frame 2 can be elastically connected to the support frame 1 through the elastic parts 24. For example, the frame body can be elastically connected to the support frame 1 through the drive shaft 21, a connecting part 25, and the elastic parts 24. The frame body can be positioned in the hollow part 11, and the frame body is spaced apart from the support frame 1 in most of regions. For example, the frame body is spaced apart from the support frame 1 in at least the leftward/rightward direction R of the electric toothbrush, so that the frame body is movable relative to the support frame 1. The vibration produced during operation of the motor 4 can drive the frame body to swing or vibrate relative to the support frame 1, and then transmit the swing or vibration to the drive shaft 21. With the drive frame 2 and the support frame 1 elastically connected and spaced apart from each other as a whole, the toothbrush head connected to the drive shaft 21 can have a certain degree of freedom of movement, so that the toothbrush head can be subjected to forces in different directions, thereby cleaning teeth and massaging gums in a better way.

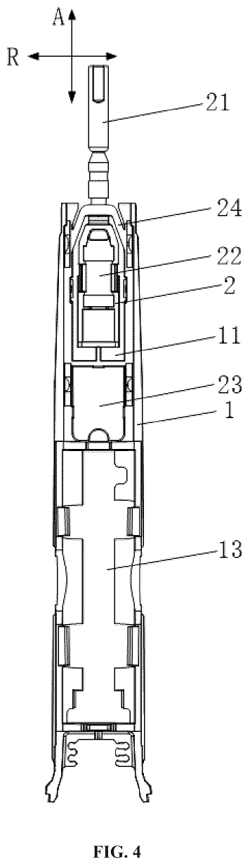

As shown in FIG. 4, the upper end portion of the frame body is formed as a first inverted U-shaped portion open toward the left and right sides of the electric toothbrush, and the drive shaft 21 can protrude upwards from the top end of the first inverted U-shaped portion. The connecting part 25 and the elastic parts 24 can be formed together as a second inverted U-shaped portion open toward the left and right sides of the electric toothbrush. The frame body, the elastic parts 24, the connecting part 25, the support frame 1, and the drive shaft 21 can be integrally connected by an injection molding process, and the second inverted U-shaped portion with a similar shape to that of the first inverted U-shaped portion is sleeved over the outside of the first inverted U-shaped portion with a spacing therebetween, which can facilitate demoulding after injection molding. The frame body can comprise a counterweight groove 23, and the counterweight 3 can be accommodated in the counterweight groove 23. Optionally, in the upward/downward direction A of the electric toothbrush, the counterweight groove 23 can be positioned on a lower side of the motor groove 22, and the counterweight 3 can be positioned on a lower side of the eccentric block 41. In the upward/downward direction A of the electric toothbrush, the drive shaft 21 can be positioned on the upper side of the motor groove 22, and the counterweight groove 23 can be positioned on the lower side of the motor groove 22. The counterweight 3 can increase the overall weight of the drive frame 2 to balance the vibration produced during operation of the motor and avoid imbalance caused by the vibration, so that the electric toothbrush can remain stable during use and that the toothbrush head can move more smoothly and efficiently.

The drive shaft 21 can be connected to the elastic part 24 through the connecting parts 25, the connecting parts 25 can be sheet-shaped, and the connecting part 25 can surround the drive shaft 21. In the upward/downward direction A of the electric toothbrush, the connecting part 25 can be spaced apart from the frame body by a distance. The connecting part 25 is connected to the support frame 1 through two elastic parts 24, and the elastic parts 24 can be positioned on the left and right sides of the connecting part 25 in the leftward/rightward direction R.

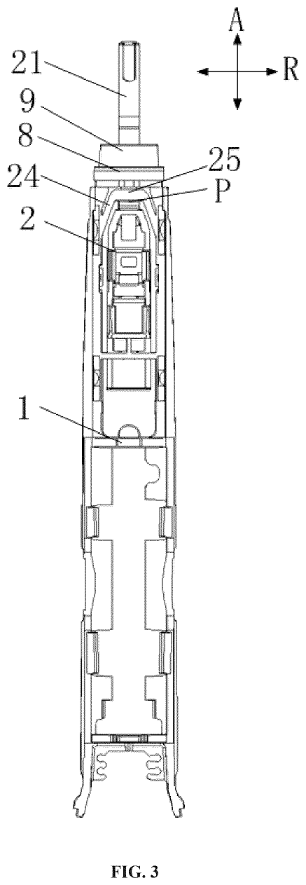

As shown in FIG. 3 and FIG. 4, when viewed along the frontward/rearward direction F of the electric toothbrush, the elastic parts 24 can be inclined relative to the leftward/rightward direction R of the electric toothbrush, and the elastic parts 24 can be closer to the rear of the electric toothbrush as they extend to the left and right sides. For example, the elastic parts 24 can be inclined by 30 to 60 degrees relative to the upward/downward direction A, and optionally, the elastic parts 24 can be inclined by 45 degrees relative to the upward/downward direction A. If the elastic parts are inclined relative to the upward/downward direction A by an angle less than 30 degrees, they are difficult to decompose a vibration component of the drive shaft 21 along the upward/downward direction A, resulting in an increase in energy loss. If the elastic parts are inclined relative to the upward/downward direction A by an angle greater than 60 degrees, the elastic parts have smaller effective deformation strokes, which will reduce the vibration transmission efficiency.

It can be understood that the elastic parts 24 arranged to be inclined relative to the upward/downward direction A enable the drive shaft 21 to absorb vibration in all three directions including the upward/downward direction A, the frontward/rearward direction F, and the leftward/rightward direction R to provide elastic compensation. When the motor 4 drives the eccentric block 41 to rotate, the inclined elastic parts 24 can produce a vector superposition effect in cooperation with a plane of rotation of the eccentric block of the motor, so that the vibration amplitude of the toothbrush head is increased, and the toothbrush head can produce compound vibration with an elliptical trajectory, which has an enhanced gingival line cleaning effect compared with a toothbrush vibrating linearly.

In the upward/downward direction A, the connecting part 25 can be positioned at the upper ends of the elastic parts 24.

The elastic parts 24 can be sheet-shaped. When viewed along the frontward/rearward direction F of the electric toothbrush, the thickness of the connecting part 25 can be greater than the thicknesses of the elastic parts 24.

It can be understood that the thickness of the connecting part 25 can be adaptively changed according to design requirements. The elastic parts 24 enable the motor 4 to drive the frame body to swing or vibrate relative to the support frame 1. The elastic parts 24 can absorb and cushion externally applied forces, such as vibration or shock during use, reduce damage to the overall structure, and thus improve the service life and grip comfort.

It is understandable that the frame body is movable in multiple directions by being driven by the motor 4, and such multi-directional movement can not only cover different surfaces of teeth, but also can more effectively remove dirt and plaque from crevices between teeth.

The elastic parts 24 can be arranged on the left and right sides of the connecting part 25 in the leftward/rightward direction R. The elastic parts 24 can be in the shape of bendable sheets, and the dimension (width) of each sheet-shaped elastic part along the frontward/rearward direction can be greater than its dimension along the leftward/rightward direction (thickness, namely, thickness in a direction perpendicular to the direction in which the elastic part 24 extends inclinedly). The thickness of the sheet-shaped elastic parts refers to a solid thickness of a single elastic part 24 of the two elastic parts 24, excluding the spacing between the two elastic parts 24.

Thus, the elastic parts are likely to undergo bending deformation along the leftward/rightward direction R of the electric toothbrush, but are not likely to undergo bending deformation along the frontward/rearward direction F of the electric toothbrush (they are still deformable). In this way, the drive frame 2 can easily swing relative to the support frame 1 along the leftward/rightward direction, and then drive the toothbrush head to swing or vibrate along the leftward/rightward direction R, thereby cleaning the teeth and/or gums.

The elastic parts 24 can have a rectangular cross section, and the connecting part 25 and the elastic part 24 can have identical dimensions along the frontward/rearward direction F.

The drive shaft 21 can have a fulcrum P thereon, and it can be understood that the fulcrum P is an artificially defined virtual position, rather than a structurally existing support point. When the motor 4 drives the drive frame 2 to swing or vibrate, the drive frame 2 can swing or vibrate around the fulcrum P. It is understandable that the fulcrum P can also be allowed to move within a certain range. For example, the vibration amplitude near the fulcrum P can be controlled at 0.1 mm to 0.5 mm. In this way, vibration resistance in the area of the fulcrum P can be reduced, so that vibration energy of the motor 4 can be more intensively transmitted to the elastic parts 24, thereby improving the vibration transmission efficiency. In the vicinity of the fulcrum P, the vibration energy is concentrated, and an impact of excess vibration on the sealing member 8 can be reduced by the vibration-absorbing effect of the elastic parts 24. At the position of the toothbrush head far away from the fulcrum P, the vibration energy is released through the drive shaft 21, and the swing amplitude is amplified to enhance the cleaning effect.

Optionally, in this embodiment, the elastic parts 24, the connecting part 25, the frame body, and the support frame 1 can each be made of a plastic material, and the elastic parts 24, the connecting part 25, the frame body, and the support frame 1 can be integrally molded. The drive shaft 21 is made of a metal, and the drive shaft 21 and the connecting part 25 can be connected integrally by an injection molding process. In this way, assembly and mounting errors and wear caused by contact fit can be reduced, so that the support frame 1 and the drive frame 2 can have higher overall structural strength and stability.

The front end of the support frame 1 can be provided, for example, with two sealing member mounting holes 12, and the two sealing member mounting holes 12 can be arranged on the left and right sides of the drive shaft 21 in the leftward/rightward direction R of the electric toothbrush. The sealing member 8 can be sleeved around the drive shaft 21, and fixing jaws of the sealing member 8 can be mounted in the sealing member mounting holes 12. The sealing member 8 can prevent water or foam from entering the inside of the toothbrush handle, and the sealing member 8 can reduce influence of vibration on the waterproof ring 9, thereby improving the sealing effect.

The connecting part 25 can be located in the same plane as the front end of the support frame 1, and the sealing member 8 can be brought into contact with the connecting part 25, so that a short distance exists between the sealing member 8 and the fulcrum P. The distance between the sealing member 8 and the fulcrum P can be 2 to 5 mm. At the position where the sealing member 8 is located, the drive shaft 21 has a smaller swing amplitude and is subjected to less resistance, and the sealing member 8 has an excellent waterproof effect.

Optionally, the distance between the sealing member 8 and the fulcrum P in the upward/downward direction A is less than ⅓ of the length of the drive shaft 21.

Optionally, the shock absorber 5 can be connected to the drive frame 2, at least a portion of the shock absorber 5 can be positioned in a gap between the drive frame 2 and the support frame 1, and the shock absorber 5 is elastic. For example, the shock absorber 5 can be foam or rubber. When the drive frame swings or vibrates, the shock absorber 5 can effectively absorb and alleviate the vibration transmitted to the support frame 1 to weaken the intensity of vibration transmitted to a user's hand, thereby improving comfort of use. The motor 4 and other components can be protected by cushioning the vibration by the shock absorber 5, and noise generated during operation of the motor 4 can also be reduced, so that the electric toothbrush is quieter during use, and user experience is enhanced. In addition, the shock absorber can also cushion external shocks, reduce damage caused by falls, and thus prolong the service life of the electric toothbrush.

In use of the electric toothbrush of the present disclosure, the electric toothbrush is turned on and powered on, so that the motor 4 starts rotating. The eccentric block 41 is rotationally driven by the motor 4, so that the frame body is swung or vibrated about the fulcrum P as an axis to transmit power to the drive shaft 21. The frame body and the toothbrush head are positioned at the two ends of the fulcrum P, respectively, and the swing or vibration of the frame body is amplified at the positions of bristles of the toothbrush head by utilizing the lever principle. The toothbrush head mounted to the drive shaft 21 can have a swing amplitude of up to 3 to 5 millimeters, and thus has a better cleaning effect.

The electric toothbrush of the present disclosure has the following advantageous effects.
(1) The drive frame 2 is driven by the motor 4 to swing or vibrate relative to the support frame 1, and thus the drive shaft 21 is driven to swing or vibrate the toothbrush head synchronously. Such design can effectively reduce vibration transmitted to the toothbrush handle, thereby reducing energy consumption and enhancing the toothbrushing effect. In addition, this structure is simple and can easily convert the rotary movement of the motor 4 into the swing or vibration of the drive shaft 21, so that its production cost is lower.
(2) The vibration is transmitted to the drive shaft 21 through the elastic parts 24, thus a difference in vibration amplitude can be achieved in the vibration transmission path, where the vibration amplitude is smaller in the vicinity of the fulcrum so that the sealing member 8 is not excessively pressed and deformed by the drive shaft 21 and can have a better sealing effect, and the vibration amplitude is larger at the upper end of the drive shaft 21 so that the toothbrush head has a higher cleaning efficiency.
(3) The drive shaft 21, the elastic parts 24, the connecting part 25, and the support frame 1 are integrally molded, so that the support frame 1 and the drive frame 2 have higher overall structural strength and better stability so as to avoid loosening of the connection and reduction of the vibration transmission efficiency caused by long-term vibration.
(4) The vibration of the drive frame 2 can be absorbed and cushioned by the elastic parts 24, so that less vibration is transmitted to the handle and then to a user's hand, the intensity of vibration transmitted to the user's hand is weakened, comfort of use is improved, and noise is reduced, so that the electric toothbrush is quieter during use, and the user experience is enhanced.
(5) The elastic parts 24 have a simple structure, and the integrally molded design is easily manufactured and assembled with a lower production cost.

It should be understood that at least some of the aspects or features of the above embodiments, implementations, or examples can be appropriately combined with each other.

It can be understood that, in the present disclosure, when the number of parts or components is not specifically limited, the number thereof can be one or multiple, where the term “multiple” refers to two or more. In the case where the number of parts or components shown in the drawings and/or described in the description is a specific quantity, such as two, three, or four, the specific quantity is usually exemplary and not restrictive and can be construed as multiple, i.e., two or more, however, this does not mean that the number “one” is excluded in the present disclosure.

In the present disclosure, unless otherwise expressly stated or defined, the terms “mount”, “assemble”, “assembling”, “couple”, “connect”, “link”, “attach”, “abut”, “communicate”, “communicating”, “conduct”, “fix”, “fasten”, and the like should be construed in a broad sense, for example, directly or indirectly. For example, connection can be fixed connection, detachable connection, or integral connection, or can be mechanical connection or electrical connection, or can be direct connection or indirect connection through an intermediate medium, or internal communication between two elements or interaction between two elements, unless otherwise expressly stated or defined. For example, communication/conduction or the like can be direct communication/conduction, or indirect communication/conduction through an intermediate medium. It will be appreciated by those of ordinary skill in the art that the specific meanings of the above terms in the present disclosure can be understood according to specific situations.

In the present disclosure, unless otherwise expressly stated or defined, a component arranged/mounted/positioned/accommodated/disposed in, within, or inside another component can be either of: the component partially or mostly positioned within the another component; and the component wholly accommodated within the another component.

Although the present disclosure is described in detail using the above embodiments, it is apparent to those skilled in the art that the present disclosure is not limited to the embodiments described in this specification. The present disclosure can be modified and implemented as a variant embodiment without departing from the spirit and scope of the present disclosure determined by the claims. Therefore, the description in this specification is for illustrative purposes only and is not intended to limit the present disclosure in any way.

What is claimed is:

1. An electric toothbrush, comprising:
a support frame provided with a hollow part;
a drive frame, wherein the drive frame is elastically connected to the support frame through elastic parts and a connecting part, the drive frame comprises a frame body and a drive shaft extending from the frame body to an upper side of the electric toothbrush, the connecting part is connected around the drive shaft, and in an upward/downward direction of the electric toothbrush, the connecting part is spaced apart from the frame body in the upward/downward direction of the electric toothbrush;
the frame body is positioned in the hollow part, the frame body is spaced apart from the support frame in at least a leftward/rightward direction of the electric toothbrush so that the frame body is movable relative to the support frame, the drive shaft is configured to be connected to a toothbrush head, a sealing member is sleeved around the drive shaft, the sealing member is mounted to the support frame closely to a position where the elastic part is connected so that a swing amplitude of the drive shaft at the sealing member is smaller than a swing amplitude of a distal end of the drive shaft, the connecting part is located in a same plane as a front end of the support frame, and the sealing member is able to be brought into contact with the connecting part; and
a motor arranged on the frame body, wherein the motor is able to drive the drive frame to swing or vibrate relative to the support frame around a fulcrum on the drive shaft, so that the drive shaft is able to drive the toothbrush head to swing or vibrate.

2. The electric toothbrush according to claim 1, wherein a distance between the sealing member and the fulcrum in the upward/downward direction is less than ⅓ of a length of the drive shaft; and
a waterproof ring is arranged over the sealing member, and the waterproof ring and the sealing member are brought into fit connection with each other.

3. The electric toothbrush according to claim 1, wherein when viewed along a frontward/rearward direction of the electric toothbrush, the elastic parts are arranged to be inclined relative to the leftward/rightward direction and the upward/downward direction of the electric toothbrush, and the elastic parts are closer to the rear of the electric toothbrush as they extend to the left and right sides.

4. The electric toothbrush according to claim 1, wherein the drive frame, the elastic parts, the connecting part, and the support frame are integrally molded.

5. The electric toothbrush according to claim 1, wherein in the upward/downward direction of the electric toothbrush, the connecting part is positioned at upper ends of the elastic parts; and
the drive shaft and the connecting part are integrally connected by an injection molding process.

6. The electric toothbrush according to claim 1, wherein the elastic part has a rectangular cross section, and the connecting part and the elastic parts have identical dimensions along a frontward/rearward direction of the electric toothbrush.

7. The electric toothbrush according to claim 1, wherein an upper end portion of the frame body is formed as a first inverted U-shaped portion open toward the left and right sides of the electric toothbrush, the drive shaft protrudes upwards from a top end of the first inverted U-shaped portion, the connecting part and the elastic parts are formed together as a second inverted U-shaped portion open toward the left and right sides of the electric toothbrush, and the second inverted U-shaped portion with a similar shape to that of the first inverted U-shaped portion is sleeved over the outside of the first inverted U-shaped portion with a spacing therebetween.

8. The electric toothbrush according to claim 1, wherein the frame body is connected with a counterweight.

9. The electric toothbrush according to claim 8, wherein an output shaft of the motor is connected with an eccentric block, the drive frame can be swung or vibrated by driving a rotation of the eccentric block by the motor, and in the upward/downward direction of the electric toothbrush, the eccentric block is positioned on a lower side of the motor, and the counterweight is positioned on a lower side of the eccentric block.

10. The electric toothbrush according to claim 1, wherein the support frame is provided with a battery accommodating groove in which a battery is mounted.
